(19) United States
(12) Patent Application Publication
(10) Pub. No.: US 2004/0167825 A1
(43) Pub. Date: Aug. 26, 2004

(54) System for optimization of drayage services

(76) Inventor: Joseph S. Nadan, Southport, CT (US)

Correspondence Address: DICKSTEIN SHAPIRO MORIN & OSHINSKY LLP, 2101 L STREET NW, WASHINGTON, DC, 20037-1526, US

(21) Appl. No.: 10/730,115

(22) Filed: Dec. 9, 2003

Related U.S. Application Data
(60) Provisional application No. 60/431,951, filed on Dec. 9, 2002.

(51) Int. Cl. G06F 17/60

(52) U.S. Cl. 705/26

(57) ABSTRACT

The present invention provides a method to improve the operational efficiency of a collaborative drayage community. According to the present invention, multiple independent (even competitive) participants in a collaborative drayage community provide resource data about the drayage resources under the participants' control. A collaborative drayage community participant having a drayage need for drayage resources may access these resource data, and drayage resources fulfilling the drayage need (based on a comparison of needed resource data to offered resource data) are determined. The drayage participant having the drayage need may then reserve one of the offered drayage resources fulfilling the drayage need. The present invention also provides a system for administering a collaborative drayage community where drayage resource data are stored in the system, and are accessible to drayage participants having a drayage needs via a network, such as the Internet.

This application claims the benefit of U.S. Provisional Application No. 60/431,951, filed Dec. 9, 2002.

### FIELD OF THE INVENTION

1. Background of the Invention

This invention relates to improving the operational efficiency of shorthaul trucking drayage and various aspects of the intermodal transportation and logistics processes.

2. Discussion of the Related Art

In intermodal transport, a load is moved between the origin and destination in the same container or in a sequence of containers, using two or more modes of transportation. For example, in a rail-truck intermodal transport, trailers or containers are carried on railroad cars in trains providing rail-line long haul service between origin and destination railhead terminals, and locally picked up and delivered by truck between the railhead terminals and shipper and receiver terminals. The local part of the transport by truck, whether it occurs at the origin point or the destination point, is termed “drayage.”

As part of an intermodal move, thousands of independent companies provide these services in proximity to hundreds of rail terminals, shipper/third party facilities, and ocean terminals or related port facilities, all of which comprise what is referred to as the drayage location. Many transportation intermediaries (“TIs”) including Intermodal Marketing Companies (commonly referred to as IMCs), freight forwarders, third party logistics providers (commonly referred to as 3PLs) and other similar entities manage both the line-haul leg (via railroad, airplane or boat) and the drayage legs (one at each end of each line-haul segment) of the transport. In each drayage location there are many independent drayage operators or brokers who compete with one another to provide drayage services using either their own assets (i.e. personnel, tractors, trailers, chassis and containers, whether owned outright or leased/rented or borrowed) or, very frequently, sub-contracting with many independent owner-operators.

Shorthaul trucking and/or drayage companies are often hired to find a specific type of equipment (i.e. trailer or container), transport it, and then drop it at a warehouse or factory until it is loaded and ready for transport to another warehouse, factory or terminal. This order is difficult to fulfill because there is no centralized database of drayage resources, companies controlling those resources, and the location and availability of those resources.

For the drayage legs of an intermodal move, a tractor (sometimes referred to as a “power unit”) is sent to a shipment pick-up point (such as a rail terminal, ocean terminal or related port facility, or shipper's facility) to transport a loaded or unloaded trailer or container to a shipment delivery point. At the shipment delivery point, the driver either stays with the trailer or container while it is unloaded or loaded or alternatively leaves the container at the terminal for later transport and picks up another trailer or container and hauls it to either the shipment pick-up point or to an alternate destination (a “reciprocal load”). In many cases, the trailer or container may not be loaded or unloaded in a reasonable amount of time and there are no loaded or empty trailers or containers ready to serve as a reciprocal load. Under these circumstances, the driver leaves the delivery point without a trailer or container, which usually requires a later return to the delivery point to retrieve the original intended reciprocal load, causing at least one and perhaps two unproductive trips termed “bobtailing.”

Drayage services are usually provided on a “round trip” basis; i.e. the operator is given a fixed fee to drive the tractor in both directions. The key to cost efficient drayage operation is matching the two legs of service with two containers/trailers so that each direction is productive in fulfilling the bi-directional obligation. When the driver, through no fault of his own, is not able to either stay with a container/trailer being loaded or unloaded, or to retrieve and remove another container/trailer from that same facility to complete the return part of his obligation, he returns without a trailer or container and is paid in full for his round trip. Since the drayage company still has an obligation to pick up the trailer or container at a later date, bobtailing represents a significant additional cost to the drayage operator or broker.

Per-diem charges for equipment are another common inefficiency widespread in current drayage arrangements. As noted above, normal intended use includes leaving the trailer or container at a terminal or other facility for later loading or unloading and the line-haul part of the transport. However, once the trailer or container is declared to be empty and ready for return to the provider of the equipment, the per-diem charges thereafter incurred usually become the responsibility of the drayage operator or broker. Frequently, a large number of trailers or containers may be declared to be empty and ready for return at the same time, and the drayage operator or broker may not have sufficient resources to retrieve and redeliver them to the equipment provider on a timely basis, resulting in an accumulation of multiple per-diem charges against the drayage operator/broker. Hence, per-diem charges represent a significant additional cost to the drayage operator or broker. Similarly, IMCs and other third party logistics companies who are customers of the drayage companies/brokers incur per-diem and other accessorial charges related to the drayage company/broker's inability to timely retrieve and redeliver empty equipment to the corresponding equipment provider, which charges are often shifted to the responsibility of the drayage operator/broker.

Another example of inefficiency in managing drayage resources arises from the need to store unused resources, such as empty containers. After a load has been hauled from a terminal to a remote destination and unloaded, the empty container is frequently returned to the terminal for subsequent later use. Storage of empty containers at shipping terminals (such as railheads and ocean terminals), may create unnecessary congestion. To relieve or prevent this congestion, unused resources may be stored at a remote destination, such as a warehouse. However, identifying available empty containers and reserving storage spaces requires an excessive amount of human effort.

As a result of the inefficiencies associated with current drayage operations, many drayage companies are marginally profitable and cannot afford to acquire electronic support to improve their operational efficiency. They are highly fragmented labor-intensive stand-alone businesses with limited access to technology and capital needed to provide the level of service required by their customers. Their current technology is primarily telephone, fax, and stand-alone computer information systems that rely upon keying of data and that do not interact with the external marketplace. They function in fast-paced and fragmented marketplaces about which little information is electronically available on a timely basis.

What is needed therefore is a system for providing timely information about drayage workflows and asset availability accessible to drayage companies. Also needed is a system for pooling and sharing assets of drayage companies. These systems would greatly increase the efficiency of the current drayage arrangement, and increase profitability of current drayage participants.

### BRIEF SUMMARY OF THE INVENTION

The present invention provides a system, together with related methods, for optimization of drayage services in a drayage community. The present invention provides a network-accessible system for matching available drayage resources with a drayage participant's drayage needs. In order to perform this matching function, the system of the present invention gathers data on the drayage participants' collective resources. These resources primarily include available containers and power units (e.g., tractors). While the present system is largely described in relation to containers and tractors, it should be understood that it can apply to all conventionally known drayage resources that perform a drayage function. The system of the present invention also receives requests for available resources in the form of criteria provided by the drayage participant in need of a resource. The system compares the data characterizing a drayage need against data characterizing available drayage resources and provides a listing of drayage resources that fill the drayage need. After the system provides a list of matching resources, the system may provide more in-depth data about matching available drayage resources to a drayage participant having a drayage need. Based on this information, a drayage participant may then reserve the resource using the system of the present invention.

Additional functionality of the system of the present invention may include: dispatch/deployment; arrival prediction; arrival confirmation; order coordination; driver and tractor coordination; in transit communication; equipment exchange; order exchange; driver/tractor sharing; subcontracting; status alerts; commercial document generation (automated and manual); event confirmations and documentation; maintenance standardization and monitoring; warehouse capacity availability (by type and with service description); yard capacity availability (with available service options); insurance information; insurance product availability and acquisition; load content visibility and management; and load planning tools.

Typical drayage participants who may use the system of the present invention include drayage carriers/brokers, equipment (e.g., power unit) owner-operators, and transportation intermediaries such as IMCs and 3PLs, described above. Typically, the system of the present invention would be located at a data center, and accessible to registered multiple independent (even competitive) drayage participants via a network such as the Internet. The present invention also provides a method for administering a drayage community using the system of the present invention.

The impact of using the invention will include improved accuracy and comprehensiveness of resource status, location and availability; reduced bobtailing and per-diem costs; and improved allocation and utilization of all available resources within the drayage community, including staff, equipment and facility assets that enable competitive drayage operators and brokers in the drayage community to improve their individual and combined profitability through the use of individual and collaborative optimization methodologies.

### BRIEF DESCRIPTION OF THE DRAWINGS

FIG. 1 is a block diagram of a drayage community.

FIG. 2 is a representative data table generated by a system of the present invention.

FIG. 3 is a representative data table generated by a system of the present invention.

FIG. 4 is a representative data table generated by a system of the present invention.

FIG. 5 is a representative data table generated by a system of the present invention.

FIG. 6 is a schematic representation of the functionality of the present invention.

FIG. 6a is a flowchart representing the steps shown in FIG. 6.

FIG. 7 is a representative web page which may be generated by the present invention.

FIG. 8 is a representative web page which may be generated by the present invention.

FIG. 9 is a representative web page which may be generated by system of the present invention.

FIG. 10 is a representative web page which may be generated by the system of the present invention.

FIG. 11 is a representative web page which may be generated by the system of the present invention.

FIG. 12 is a representative web page which may be generated by the system of the present invention.

FIG. 13 is a representative web page which may be generated by the system of the present invention.

FIG. 14 is a block diagram representing accessibility to the system of the present invention via the Internet.

FIG. 15 is a flow chart showing the relationship between the steps of the method of the present invention.

### DETAILED DESCRIPTION OF THE INVENTION

In the following description, reference is made to the accompanying drawings which will serve to illustrate exemplary embodiments of the invention. The description provides sufficient detail to enable those skilled in the art to practice the invention. Of course other embodiments may be used and various changes may be made without departing from the scope of the present invention. The scope of this invention is defined by the appended claims.

In a preferred embodiment of the present invention, multiple independent (even competitive) drayage participants organize to form collaborative drayage communities (“CDCs”). CDCs may be formed where drayage operations occur. For example, when an intermodal marketing company tenders a shipment from one point to another, such as from Milwaukee, Wis. to San Diego, Calif., it may be routed using a railroad line haul from Chicago to Los Angeles and two drayage runs, one from Milwaukee to Chicago and the second from Los Angeles to San Diego. The first drayage run takes place within the Chicago Drayage Community, which includes both Chicago and Milwaukee; the second drayage run takes place within the Southern California Drayage Community, which includes both Los Angeles and San Diego.

Participants in a CDC control drayage resources. Drayage resources include the components essential to drayage activity, particularly containers (both loaded and empty) and power units. Furthermore, an unavoidable consequence of drayage activity is the continual generation of drayage needs. As described above, a drayage need may arise where a drayage participant delivers a container to a shipping destination and it is not feasible for the driver to wait for the container to be loaded or unloaded before making a return trip. To avoid an unproductive return trip, the drayage participant may seek an available container that requires haulage. Here, the desirability of hauling an available container rather than bobtailing makes that available container a drayage need for the seeking drayage participant.

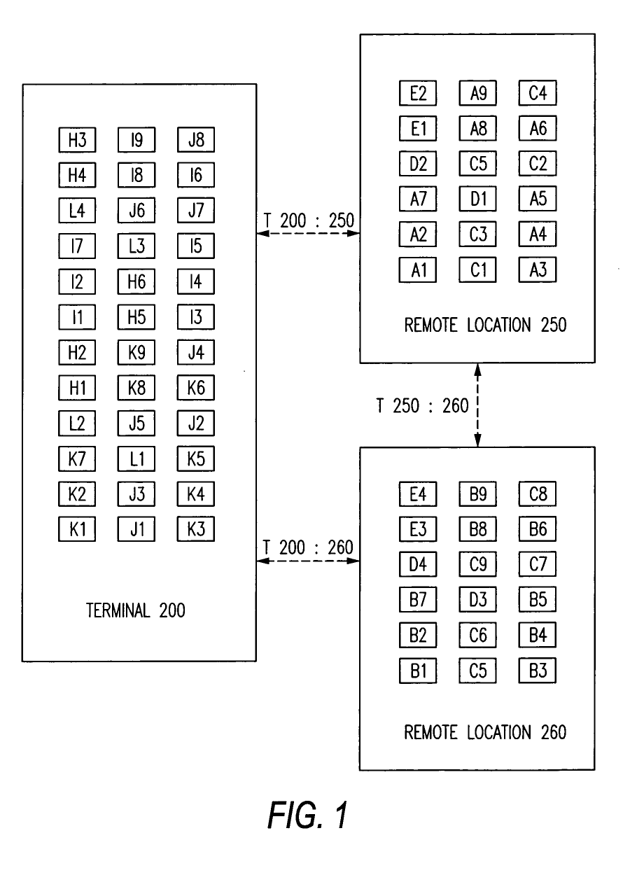

Referring to FIG. 1, a schematic representation of a conventional drayage community is shown wherein a multitude of line haul terminals is illustrated by Terminal 200. Remote Locations 250, 260 represent two possible drayage shipping destinations. Terminal 200 and Remote Locations 250, 260 represent the multiple operational locations within the drayage community in a geographic area. The transit times between each of the locations are represented by T200:250, T200:260 and T250:260 respectively. Present within these operational locations are various drayage resources (here containers), represented in FIG. 1 with alphanumeric identifiers, with each letter representing current control by a drayage participant and each number representing a serial number for the particular drayage resource.

Still referring to FIG. 1, a review of the drayage resources at remote location 250 reveals that none of these containers is under the control of drayage participant B. As a consequence, if drayage participant B is hired to ship container H3, for example, from Terminal 200 to remote location 250, there is no container available for company B to haul on a productive return trip, in the event container H3 is not available for a return trip, as would be the case if container H3 required an impermissibly lengthy amount of time to unload. Company B in that instance will suffer the inefficiency of the power unit's bobtail trip of duration T200:250, which must be made in order to arrive at terminal 200 in time for a follow-on job scheduled for a set time. The bobtail occurs regardless of other containers available for immediate shipping from remote location 250 since these containers are under the control of other drayage companies and not company B.

This shortcoming in providing available drayage resources to meet drayage needs (here, the need for a container) and resulting inefficiencies may be resolved where the multiple independent (even competitive) drayage participants in a drayage community join to form a CDC. In a CDC, drayage participants may access the offered drayage resources of other drayage participants. This greatly increases the possibility that a drayage participant will be able to fill its drayage needs and avoid inefficiencies that currently exist in conventional drayage operations. For example, referring to FIG. 1, if company B is included in a collaborative drayage community with the other drayage company-participants, potential available containers at remote location 250 increases from zero to 18. The possible advantages of forming a CDC should be apparent from this example.

Effectively and profitably sharing drayage resources among multiple independent (even competitive) drayage participants requires complete, real-time information about the drayage resources and the ability to secure drayage resources. The system of the present invention fulfills these needs.

Returning to the example provided above, where company B has delivered container H3 to remote location 250 and has a resulting drayage need for an available container, an embodiment of the system of the present invention allows company B to access information about the containers located at remote location 250. Company B may then determine whether any containers at remote location 250 would suitably meet company B's drayage need and allow the company B's power unit to return to terminal 200 in time for a scheduled follow-on job. If so, company B may reserve a suitable container located at remote location 250.

According to this embodiment of the present invention, the driver for company B would determine that container H3 will not be available for a return trip to terminal 200 in a feasible amount of time. The driver would then inform a dispatcher having network access to the system of the present invention. It having been determined that company B has a drayage need, the dispatcher may access information about the offered resources of the other drayage participants in an effort to determine whether a container is available to meet company B's drayage need. In doing so, a dispatcher may provide the system with certain data or criteria about company B's drayage need from which the system will yield a list of all drayage resources matching the provided criteria. These data may include criteria such as: controlling entity; current location; destination location; travel and availability time parameters, type and sub-type of resource, and financial data, such as per-diem rates. Alternatively, the dispatcher may simply request a listing of all resources under the control of every drayage participant.

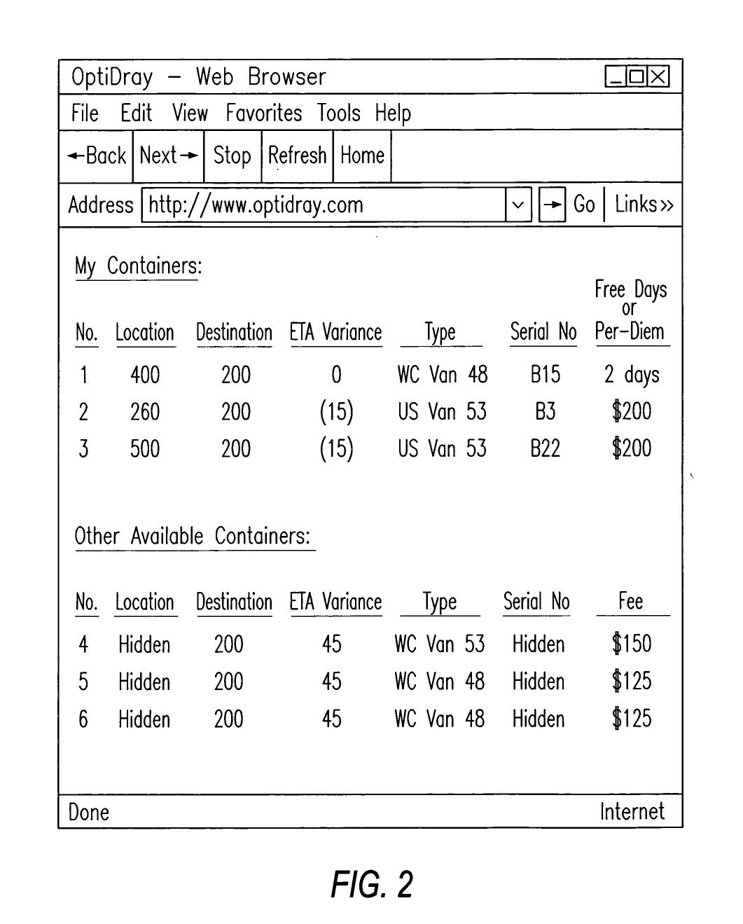

FIG. 2 shows a possible list of resources that may be provided by the system in response to a query from company B regarding the drayage need described above. In response to the query, the system provides company B data on drayage resources both under the control of company B and under control of other drayage participants. The dispatcher first evaluates the drayage resources within his own company. Resource 1 requires the driver to drive from Remote Location 250 to Remote Location 400 to pickup WC Van 48 B15 that still has two free days storage time and if everything goes perfectly will get him back to Terminal 200 just in time for his next follow-on job. Containers 2 and 3 would save his company $200 in currently accruing per-diem charges but would make the driver 15 minutes late for the follow-on job.

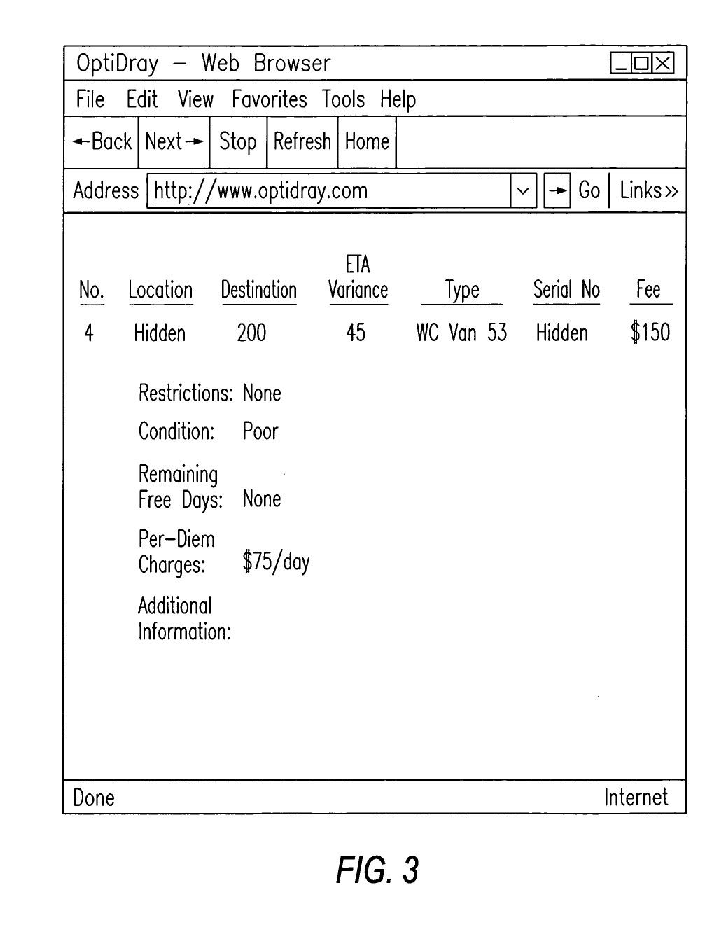

The dispatcher next evaluates the drayage resources offered by other participants within the Collaborative Drayage Community. As shown in FIG. 2, some information is hidden to prevent users from circumventing the system and privately arranging off-system transactions. Container 4 appears potentially to meet company B's drayage need. Company B would receive a payment of $150 to return container 4, a 53-foot type WC Van (serial number hidden) to Terminal 200 with 45 minutes of spare time before the follow-on job. Referring to FIG. 3, company B's dispatcher may request more information about container 4. The system provides additional information about container 4, including restrictions, condition, remaining free days, and per-diem charges. On the basis of this information, company B's dispatcher may decide to reserve container 4 to fulfill company B's drayage need.

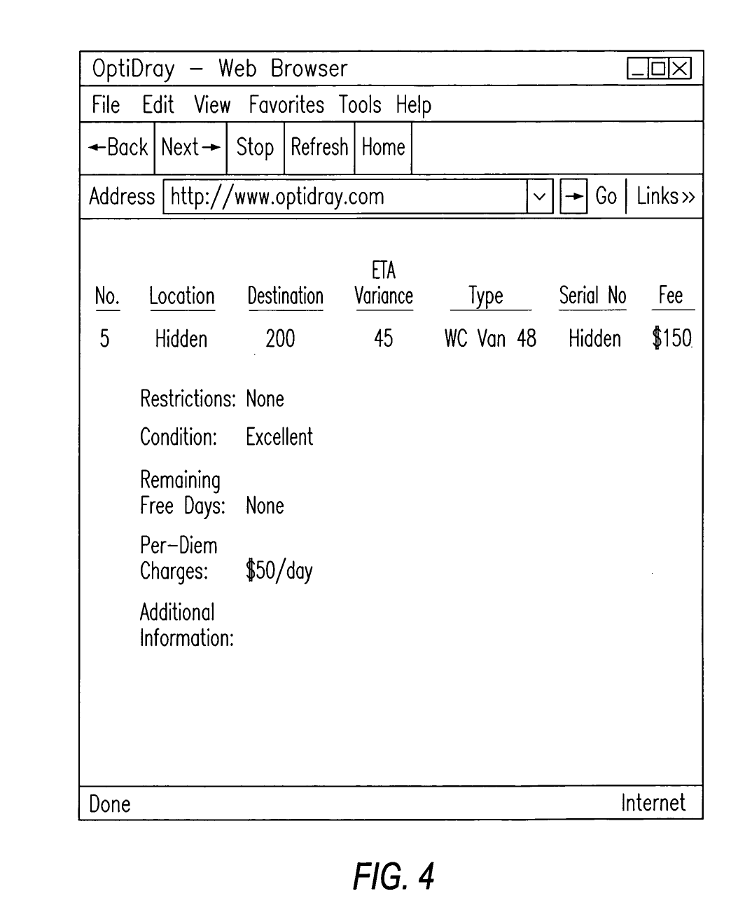

If company B's dispatcher decides not to reserve container 4, the system may provide additional information about the other containers listed in FIG. 2. Referring to FIG. 4, the system provides additional information about container 5. The dispatcher requests this job and the system transfers control of container 5 to company B. Transfer of control is typically contingent on the execution of an interchange agreement between the companies involved. The agreement may be pre-existing between the parties, or may be newly proposed by the system, which proposal company B in this case must accept to execute the agreement and continue the transaction. Hidden company E agrees to pay company B $125 for assuming responsibility for container 5, a 48-foot type WC Van (serial number hidden). The dispatcher is notified that the request has been accepted and is given the correct serial number and precise yard. For the sake of simplicity, it should be assumed that container 5 has serial number E1, which represents the drayage resource labeled “E1” shown at remote location 250 in FIG. 1. The dispatcher then informs his driver of the serial number and precise yard location of drayage resource E1, and directs the driver to transport container E1 to Terminal 200. Although container E1 in this case is located at remote location 250, it must be emphasized that the present system provides the flexibility to view and reserve resources available at alternate locations, e.g., remote location 260. Indeed, this may make sense, particularly when no reciprocal is available at the location of the participant's power unit.

Upon completion of the transaction, company B acquires the complete obligation for container E1. It should be noted that company B also still retains its obligation for the eventual return of Van H3. If for any reason container E1 is not returned to Terminal 200 then company B, and not company E, is responsible for any further per-diem charges.

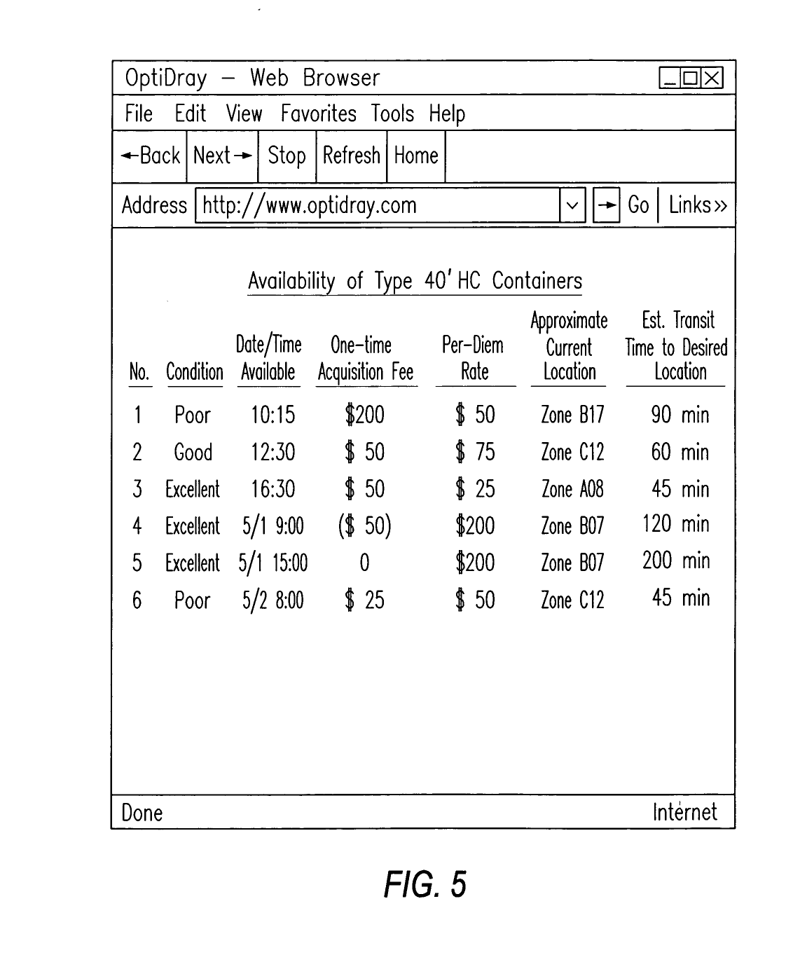

It should be apparent that the present system provides drayage participants access to information about drayage resources that may be applied to drayage needs other than those generated by a potential unproductive trip. For example, instead of being hired to ship container H3 from terminal 200 to remote location 250, company B may be hired by an intermodal marketing company simply to locate a specific type or sub-type of container within the CDC and deliver it to a desired location. A dispatcher for company B may then query the system for resources (i.e. containers) matching the desired type. Referring now to FIG. 5, the system provides a listing of all participants' resources matching the entered data, here the type of container needed. As discussed above, the dispatcher may evaluate the alternatives and request control of a suitable container. Other possible drayage resources that may be accessed through the system include loads to be picked up (i.e., not pre-loaded in a container); space for storing drayage resources; and drayage services such as cross-docking or maintenance.

Although the drayage needs and resources discussed in the examples provided above have been containers, it should be clear that other drayage resources may be accessed via the system of the present invention. For example, power unit owner-operators may provide access to their drayage resources (i.e., power units) via the system, thereby allowing shipping companies or brokers to arrange a drayage pick-up using the system. That is, a company expecting the arrival of an available loaded container at a shipping terminal has a “drayage need” for a power unit, and thus may access power units as “drayage resources” using the system of the present invention.

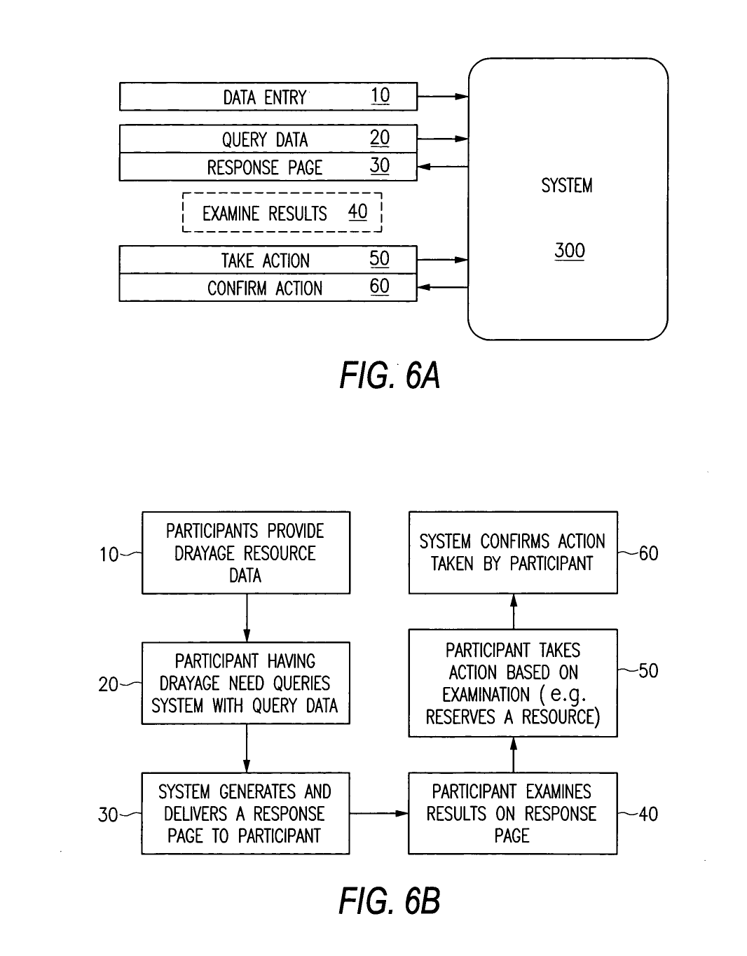

As mentioned above, the system of the present invention may be remotely accessible via a network such as the Internet. This allows collaborative drayage community participants conveniently to both provide data about their resources and to access data about drayage resources offered by other members of the collaborative drayage community, and to book available resources, if desired. FIG. 6 provides a schematic representation of the present system's member functionality.

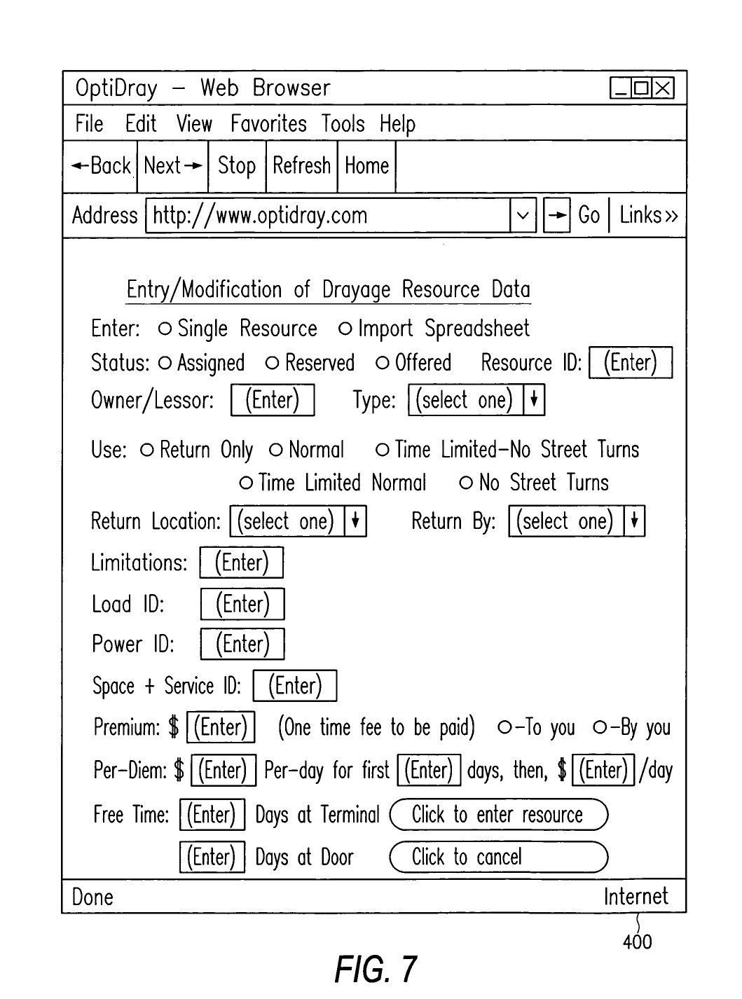

Referring to FIG. 6 and FIG. 6A, at step 10, collaborative drayage community participant members provide data about their drayage resources to the system 300. Resource data may be entered via a drayage participant's computer system located remotely from the system of the present invention, but in communication with the present system via a network, such as the Internet. Typically, the present system communicates a prompt or request (which may be a web page) for resource data, described more fully below with reference to FIG. 7. Drayage resource data may be provided to the system by entering keystrokes on conventional computer keyboard into the system prompt or request. Alternatively, data may be entered by selecting, using a computer mouse, predetermined data values presented by the system prompt. Drayage resource data may also be provided by exporting data in a spreadsheet or other electronic file directly to the system of the present invention via a network such as the Internet.

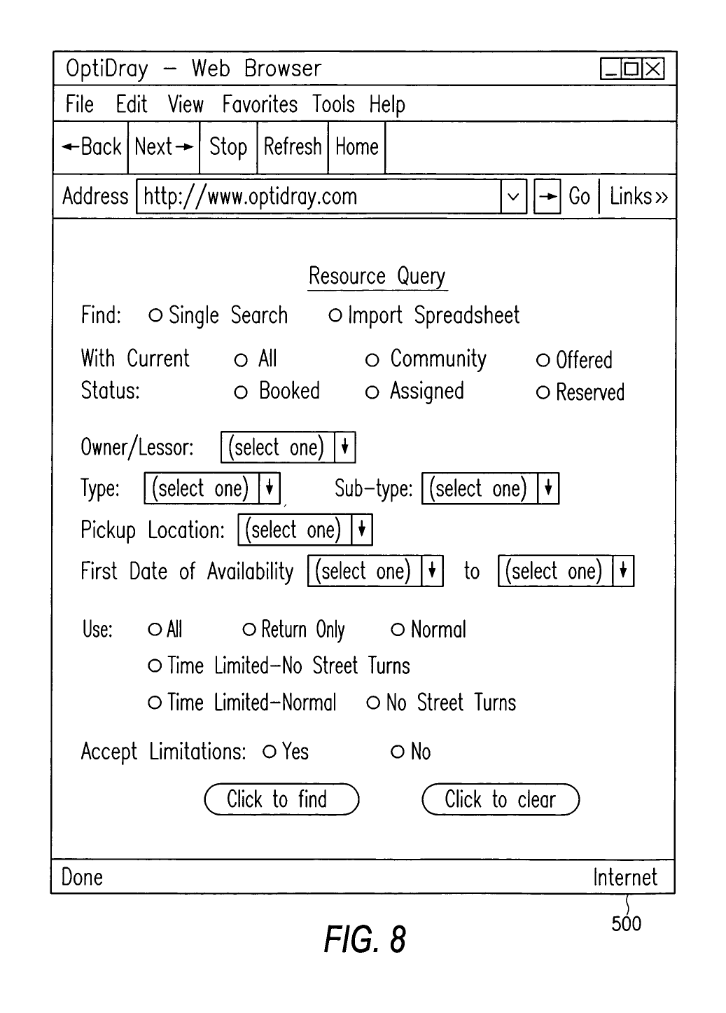

When a drayage need arises, a participant queries the system at step 20 using data or criteria specific to the drayage need. Query data may be provided to the present system by a drayage participant in any of the same manners resource data may be provided, as described above. Typically, this would entail providing data through keystrokes or mouse input or transferring a file on a remote computer in response to a prompt such as a web page shown in FIG. 8, described below.

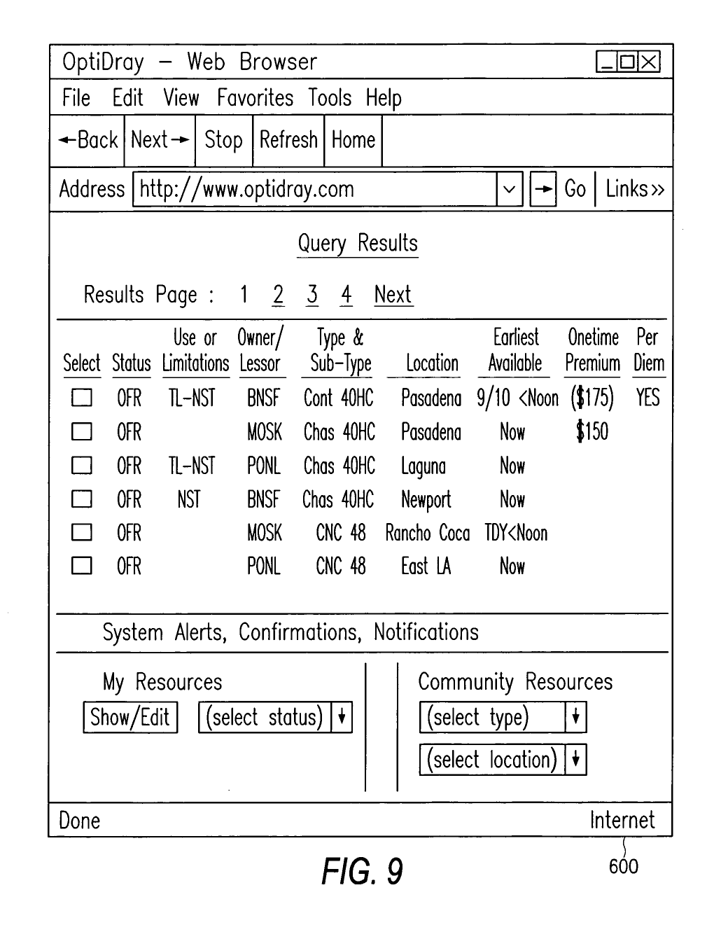

After the query data have been provided, the system at step 30 reviews previously entered data against the query data or criteria and generates a response page listing matching results. These matching results are retrieved by a computer processor included in the system of the present invention. The computer processor executes a comparison of query data with drayage resource data stored in the system. The drayage resource data may be stored by any electronic storage means known in the art including any conventional computer memory. The results may be provided in electronic format such as a web page 600, shown in FIG. 9 and described below. These results are transmitted from the system to the querying participant via a network such as the Internet.

Having received the results, the participant examines and evaluates the results at step 40. This is typically performed by visually comparing and selecting from among the results listed at step 30 and selecting from among the offered drayage resources. After determining a suitable course of action based on the results, the participant at step 50 takes action, such as reserving (i.e., taking control of) an available drayage resource. Although the steps of comparing results provided by the system at step 30 and reserving a drayage resource are typically performed by a human agent of the drayage participant, it is contemplated that a drayage participant may interact with the present system by a computer functioning according to a predetermined evaluation-reservation algorithm.

At step 60, the system confirms the action taken by the participant at step 50. Every user (including the system as the root user) request is logged to a file with a unique record number, date and time of action, unique username, and all necessary parameters to fully characterize the action. These files may be used to generate reports including but not limited to transaction invoices, equipment identification and location, and system performance measurement.

In order to maximize the utility of the system of the present invention, drayage participants may enter data falling in a multitude of data fields about the participants' resources. Referring now to FIG. 7, a drayage participant provides data to the system, for example, via a web page 400. As evident from FIG. 7, data about a participant's resources may be entered one resource at a time, or from an imported spreadsheet. Examples of data about a drayage participant's drayage resources are status, such as assigned, reserved, and offered (shown to CDC members for their possible use); resource type (e.g., container); resource sub-type (e.g., size, refrigerated); equipment ID; location; availability; use restrictions; and limitation notations; return location; return date and time; per-diem costs; and free time values. Of course it should be obvious that these data are by way of example only and that a system according to the present invention may be designed to accept any number of relevant categories of data from drayage participants about their drayage resources. It should also be clear that the categories may vary depending on the type of drayage resource being characterized.

Drayage participants may access the system and modify data for resources they control. Furthermore, drayage participants may control the status of their drayage resources via the system. Referring to FIG. 7, where the drayage resource is a container, a drayage participant may assign the container a load, a power unit, or a space and service status. This has the ultimate effect of internally “booking” a participant's own resource and making the resource unavailable to other drayage participants.

Data for the drayage participants' resources having been provided to the system, drayage participants with drayage needs may query the system for drayage resources suitable for their needs, as in web page 500 shown in FIG. 8. As shown in web page 500, a drayage participant with a drayage need may enter query data according to the criteria of the drayage need. Examples of query data that may be provided include: resource status, resource owner/lessor, resource type and sub-type, location, availability time and date, and use restrictions. As with resource data described above, these categories are not exhaustive. However, it should be noted that no query data may be entered which does not have a corresponding resource data field since a resource cannot be located based on query data which does not exist in the resource profile. Also similar to the resource data described above, query data may be provided on a query-by-query basis or by importing query data from a spreadsheet, as shown in FIG. 8. The drayage participant having a drayage need may initiate the query for suitable drayage resources after query data have been entered.

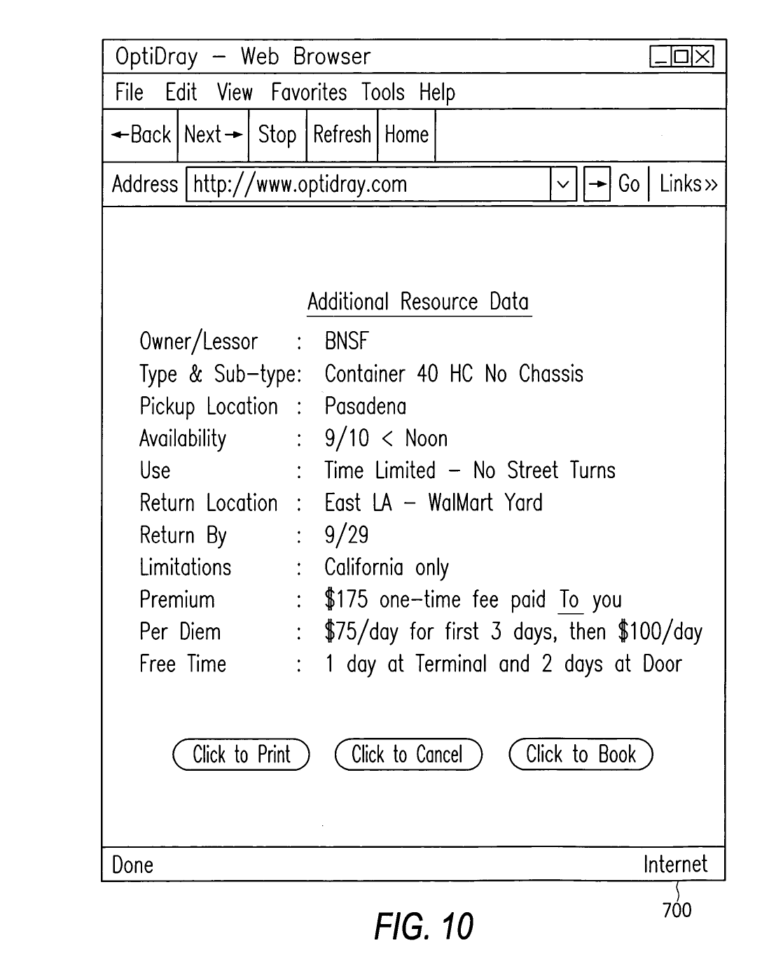

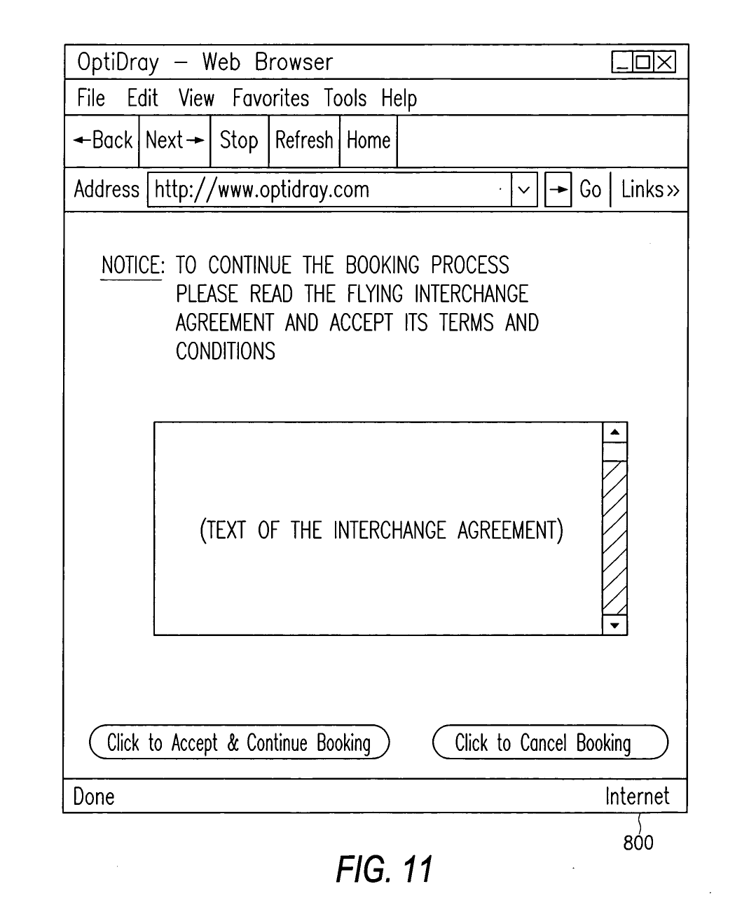

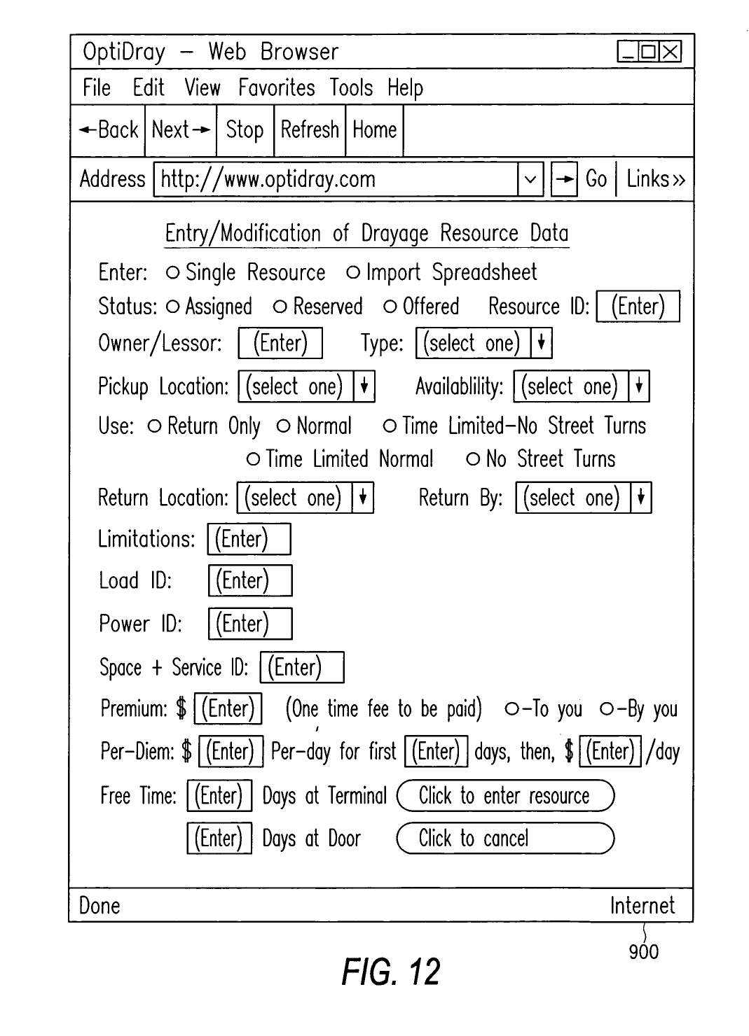

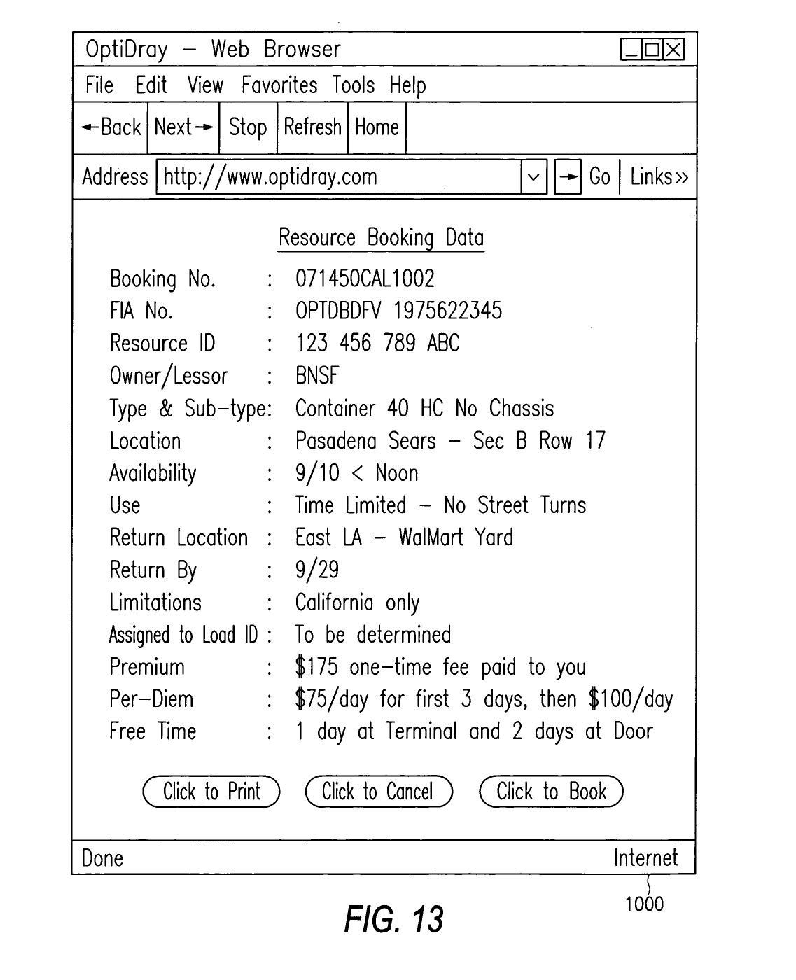

Referring now to web page 600 in FIG. 9, the system of the present invention generates a list of drayage resources matching the entered query data by comparing the query data against the resource data for each drayage resource. The list contains a multitude of resource data for each drayage resource, which the drayage participant having a drayage need may inspect to gauge the suitability of the available resources. The querying drayage participant may access additional information about any drayage resource provided by the system in response to the query. Where the drayage participant requests additional data on a drayage resource not under that participant's own control, the drayage participant may be provided access to additional data the participant may evaluate in determining whether the selected drayage resource is appropriate for the drayage need, as represented in FIG. 10, web page 700. The querying drayage participant may then initiate booking or reserving the selected resource, as shown in FIG. 10. As mentioned above, the system at this point may verify whether an agreement such as a “flying interchange agreement” has been executed between the querying drayage participant and the controlling participant. If not, the system may present the agreement to the querying drayage participant as represented by web page 800 in FIG. 11. The querying drayage participant must agree to the proposed terms to commence the transaction.

Where the drayage participant requests additional data about a drayage resource that is in fact under that participant's control, the drayage participant may be directed to a web page 900 shown in FIG. 12, which is the selected resource's data profile as entered by the controlling drayage participant. Here, the querying drayage participant may modify the data settings to effect a booking or reservation of that participant's own drayage resource. The booking is confirmed to the querying drayage participant, as in web page 1000 shown in FIG. 13. Data that may have been previously hidden in order to prevent drayage participants from circumventing the system, may be revealed to the querying participant in this confirmation. When a selected drayage resource is booked or reserved and confirmed, the system is updated to reflect this new status.

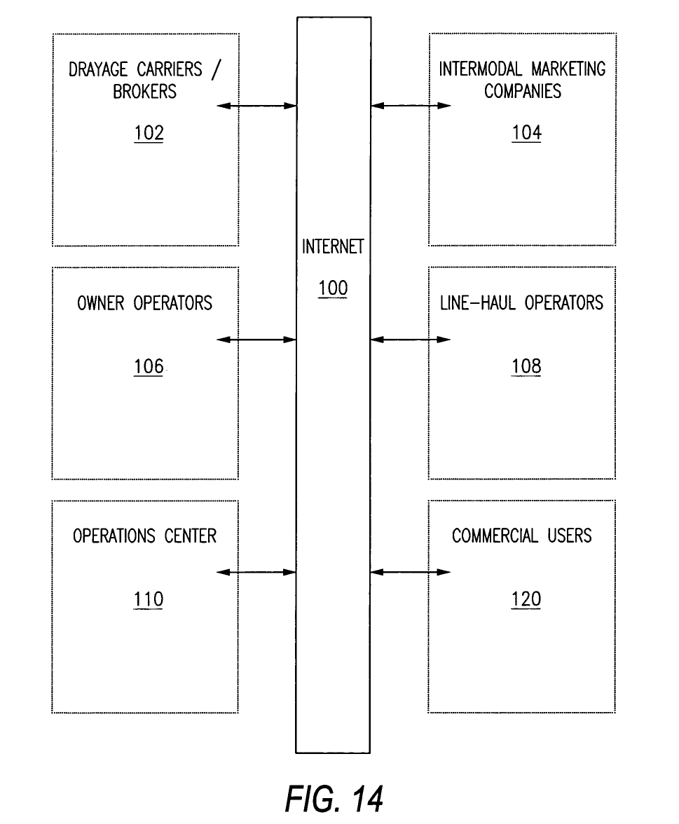

As mentioned previously, the system of the present invention may be network accessible via network such as the Internet. This provides convenient access to a multitude of drayage participants. A block diagram representing the system's accessibility to is shown in FIG. 14. Potential drayage participants include drayage carriers/brokers 102, IMCs 104, owner-operators 106, line-haul operators 108, and commercial users 120. The system operations center 110 may provide the actual physical location of the system of the present invention, which is accessible to all drayage participants via a network (in this case Internet 100) allowing remote, real-time participation in the system.

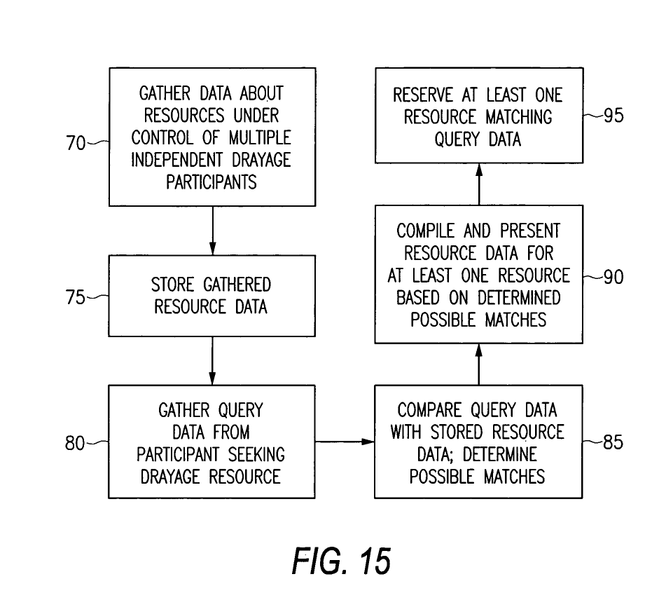

The present invention also provides a method for administering drayage resources located in a collaborative drayage community. The steps involved correspond to the functionality of the system described above. Referring to FIG. 15, at step 70, resource data about the drayage resources located under control of multiple independent (even competitive) drayage participants are gathered, and at step 75, these gathered resource data are stored, e.g., in a hard-copy ledger or in a computer database. At step 80, query data are gathered. These data characterize drayage resources a querying drayage participant seeks. At step 85, these query data are compared against the resource data previously gathered at step 70, and resources having resource data matching the query data are identified. This matching may be accomplished manually (by human comparison), or by a predetermined matching algorithm. At step 90, at least one matching drayage resource is compiled and presented. Finally, at step 95, a matching drayage resource included on a list at step 90 is reserved for the use of the drayage participant having a drayage need. It should be clear that the method described above may be practiced either at a location remote from the locations of the collaborative drayage community participants, or may be practiced by the community participants themselves at their places of business. A central administrator is not necessarily required where collaboration and cooperation among the CDC participants provides sufficient sharing of information for each participant to practice this method individually.

It should be readily understood that the present invention can be modified in the manners set forth herein as well as to any number of variations, alterations, substitutions or equivalent arrangements not heretofore described, but which are commensurate with the spirit and scope of the invention in order to obtain a desired functionality. For example, it should be understood that additional system features are contemplated by the present invention. Accordingly, the invention is not to be seen as limited by the foregoing description, but is only limited by the scope of the appended claims.

What is claimed as new and desired to be protected by letters patent of the united states is:

1. A system for administering a collaborative drayage community comprising:
a processor;
memory operationally attached to said processor;
an input device operationally attached to said processor;
storing means for storing:
a plurality of drayage resource data fields, and
drayage resource data associated with at least one drayage resource, said drayage resource data corresponding to at least one of said plurality of drayage resource data fields;
receiving means for receiving query data, said query data associated with at least one drayage need, and said query data corresponding to at least one of said plurality of drayage resource data fields;
retrieval means for retrieving, based on a match between said query data and said drayage resource data, a list of at least one drayage resource; and
delivery means for delivering said list of at least one drayage resource and said drayage resource data associated with each of said drayage resources.

2. The system of claim 1 wherein said drayage resource is a container.

3. The system of claim 1 wherein said drayage resource is a power unit.

4. The system of claim 1 wherein said drayage resource is a load.

5. The system of claim 1 wherein said drayage resource is a storage space.

6. The system of claim 1 wherein said drayage resource is a service.

7. The system of claim 1 wherein said plurality of drayage resource data fields comprises a controlling entity.

8. The system of claim 2 wherein said controlling entity is an owner.

9. The system of claim 2 wherein said controlling entity is a lessor.

10. The system of claim 1 wherein said plurality of drayage resource data fields comprises a resource type field.

11. The system of claim 1 wherein said plurality of drayage resource data fields comprises a serial number field.

12. The system of claim 1 wherein said plurality of drayage resource data fields comprises a physical location field.

13. The system of claim 1 wherein said plurality of drayage resource data fields comprises physical description field.

14. The system of claim 1 wherein said plurality of drayage resource data fields comprises a time available field.

15. The system of claim 1 wherein said plurality of drayage resource data fields comprises an acquisition fee field.

16. The system of claim 1 wherein said plurality of drayage resource data fields comprises a per diem rate field.

17. The system of claim 1 further comprising:
reserving means for reserving a drayage resource; and
confirming means for confirming the reservation of a drayage resource.

18. The system of claim 17 further comprising agreement proposal means for proposing an interchange agreement.

19. The system of claim 1 wherein said delivery means delivers exactly one drayage resource having resource data that best match said query data according to a predetermined matching algorithm.

20. A system for administering a collaborative drayage community comprising:
a processor;
memory operationally attached to said processor;
an input device operationally attached to said processor;
a storage device for storing:
a plurality of drayage resource data fields, and
drayage resource data associated with at least one drayage resource, said drayage resource data corresponding to at least one of said plurality of drayage resource data fields;
a receiving unit for receiving query data, said query data associated with at least one drayage need, and said query data corresponding to at least one of said plurality of drayage resource data fields;
a retrieval unit for retrieving, based on a match between said query data and said drayage resource data, a list of at least one drayage resource; and
a delivery unit for delivering said list of drayage resources and said drayage resource data associated with each of said drayage components.

21. A method for administering a collaborative drayage community comprising the steps of:
gathering data from drayage community participants regarding said participants' drayage resources;
causing said data to be stored;
gathering query data;
comparing said query data against said drayage resource data; and
identifying said drayage resources having resource data that match said query data.

22. The method of claim 21 further comprising the step of reserving at least one of said drayage resources having resource data that match said query data.

23. The method of claim 21 further comprising the step of confirming a reservation for a drayage resource.

24. The method of claim 21 further comprising the step of executing an interchange agreement.

25. The method of claim 21 wherein said step of identifying said drayage resources having resource data that match said query data is accomplished according to a predetermined matching algorithm.

26. The method of claim 21 wherein said drayage community participants include drayage operators.

27. The method of claim 21 wherein said drayage community participants include drayage brokers.

28. The method of claim 21 wherein said drayage community participants include owner-operators.

29. The method of claim 21 wherein said drayage community participants include intermodal marketing companies.

30. The method of claim 21 wherein said drayage community participants include line-haul operators.

31. The method of claim 21 wherein said drayage resources include containers.

32. The method of claim 21 wherein said drayage resources include power units.

33. The method of claim 21 wherein said drayage resources include loads.

34. The method of claim 21 wherein said drayage resources include storage spaces.

35. The method of claim 21 wherein said drayage resources include services.
